(19) United States
(12) Patent Application Publication
(10) Pub. No.: US 2008/0196206 A1
(43) Pub. Date: Aug. 21, 2008

(54) APPARATUS FOR USE IN MOUNTING A MOVABLE DOOR LEAF ON AN OVERHEAD TRACK

(75) Inventors: Lin Chen, Dongguan City (CN); Daniel Yang, Dongguan City (CN)

Correspondence Address: RABIN & Berdo, PC, 1101 14TH STREET, NW, SUITE 500, WASHINGTON, DC, 20005, US

(73) Assignee: Nien Made Enterprise Co., Ltd.

(21) Appl. No.: 11/770,819

(22) Filed: Jun. 29, 2007

(30) Foreign Application Priority Data
Feb. 15, 2007 (CN) 200720005765.X
Apr. 20, 2007 (TW) 096206411

(51) Int. Cl. E05D 15/06

(52) U.S. Cl. 16/87 R

(57) ABSTRACT

Apparatus for use in mounting a movable door leaf on an overhead track includes a door leaf mounted assembly having a hanging member and a mounting bracket, and a carriage assembly having a support bracket and a moving mechanism. The support bracket has a side opening forming a channel for the hanging member to pass through and a slot extending downwardly therefrom the channel in relatively smaller depth and width comparatively to the channel. The channel includes a first portion connected to the slot and, and a second portion partially connected to the slot with larger depth comparatively to the first portion. A shoulder is formed between the first and second portions. The hanging member passes through the channel to rest against at an end adjacent to the second portion, and the top part of the hanging member vertically hangs down to rest against the shoulder and the support bracket.

### CROSS-REFERENCE TO RELATED APPLICATIONS

This non-provisional application claims priority under 35 U.S.C. § 119(a) on Patent Application No(s). 096206411 filed in Taiwan, R.O.C. on Apr. 20, 2007 and 200720005765.X filed in China on Feb. 15, 2007, the entire contents of which are hereby incorporated by reference.

### BACKGROUND OF THE INVENTION

1. Field of the Invention

The present invention relates to an apparatus for use in mounting a movable door leaf on an overhead track, and more particularly, to an apparatus for a sliding door installation along a horizontally extending track mounted in the door opening, which can be disassembled/assembled easily.

2. Related Art

To flexibly and sufficiently utilize a large enclosed space, a preferred approach is to section the space into plenty of smaller compartments by movable partitions. Sometimes, two separated compartments should meet various requirements, for example, the two subdivided compartments should be maintained at well-ventilated condition, kept in high level of privacy, or installed with an accessible door is highly desirable. Therefore, such a flexible partition should comprise the following specific characteristics: first, the partition is capable of sliding along a track as to achieve a separating effect even for a long distance circumstance by the combination of multiple partitions installations; second, the partition must be capable of being rapidly dissembled or folded without the assistance of a tool, in which the partition is rapidly assembled when needed, and it can be disassembled or folded if desired; furthermore, the partition also can be classified into varying types with regard to the functions as, for example, an opaque baffle panel, a light-transmissive baffle panel, ventilation baffle panel, a light-transmissive or opaque shutter door or door leaf, and so on.

Referring to FIG. 1, in U.S. Pat. No. 3,829,929, a folding-door hanging device 10 having an emergency releasing structure is disclosed, in which a movable buckle 11 is installed on top of a door leaf 111 (or partition) to buckle with or release from a stud snap 121 mounted on a pulley block 12 of a slide rail. In above-described prior art, the door leaf (or partition) can be rapidly released. However, as the user intends to adjust the height of the door leaf (or partition), the whole door leaf has to be removed from the slide rail before processing the subsequent adjustment along the shank and once finished, the whole door leaf has to be reattached back into place. While this may be time-consuming and involve lot of effort in the case that the height adjustment is not satisfied, then the user has to perform the repetitive steps mentioned above to detach, adjust and reattach the door leaf until the desired height is reached.

Furthermore, referring to FIG. 2, in U.S. Pat. No. 6,209,171, a movable-door mounting assembly 15 is disclosed, in which a flexible releasing/locking device 16 is installed on top of a door leaf, and a shift lever 161 thereof is used to buckle with or release from a stud snap 171 mounted on a pulley block 17 of a slide rail. However, this invention may also have the disadvantage indicated above as U.S. Pat. No. 3,829,929. Even if the user may attempt to adjust the height of the door leaf without detaching it from the slide track, as the distance between the upper extremity of such door leaf and the slide track is substantially small, making the adjustment work essentially inconvenient to accomplish.

### SUMMARY OF THE INVENTION

In view of the above disadvantages, in order to solve the technical problems, the present invention provides a hanging assembly structure, in which the structure for supporting and suspending the hung door leaf and the structure for releasing (or locking) the hung door leaf are of different and separate devices, therefore, when the hung door leaf is released or locked, it is not necessary to bear the substantial weight of the door leaf itself.

To solve the above problems, the present invention provides an apparatus for use in mounting a movable door leaf on an overhead track, which includes a door mounted leaf assembly, having a hanging member and a mounting bracket assembled at upper edge of the door leaf for hanging the door leaf thereon; and a carriage assembly, having a support bracket with a moving mechanism assembled thereon for traversely sliding along the overhead track. The support bracket is opened with a pre-formed channel at a side opening and a slot extending downwardly from the channel, and a width and a length of the slot are comparatively smaller than those of the channel. The channel includes a first portion completely connected to the slot and having a relative small depth and a second portion partially connected to the slot and having a relative large depth. In addition, a shoulder is formed therebetween the first portion and the second portion.

The above apparatus for use in mounting a movable door leaf on an overhead track further includes a manually actuated releasing member, mounted at inner side surface of the upper portion of the support bracket and being capable of moving therein between a first position and a second position. The manually actuated releasing member has a stopper, in which when the manually actuated releasing member moves to the first position thereof (inoperative position), the stopper limits the movement of the hanging member therein between the second portion and the shoulder, so as to prevent the hanging member from inadvertently moving out of the side opening; and when the manually actuated releasing member moves to the second position thereof (releasing position), the stopper is kept away from the hanging member, allowing the hanging member to move freely.

To solve aforementioned problems, the present invention provides another apparatus for use in mounting a movable door leaf on an overhead track, which includes a door mounted leaf assembly, having a hanging member and a mounting bracket disposed at upper edge of the door leaf for suspending the door leaf; a carriage assembly, having a support bracket with a moving mechanism assembled thereon, in which the moving mechanism is arranged with the overhead track, so as to traversely slide thereon along the overhead track. The support bracket is opened with a pre-formed channel at a side opening for the hanging member to pass through and a slot extending downwardly from the channel, in which a width and a length of the slot are comparatively smaller than those of the channel; the slot has a releasing end close to the side opening and a closing end away from the side opening; and a manually actuated releasing member, mounted at inner side surface of the upper portion of the support bracket and being capable of moving therein between a first position and a second position. The manually actuated releasing member has a stopper. The hanging member passes through the channel and the slot to rest against the closing end of the slot. When the manually actuated releasing member moves to the first position thereof, the stopper limits the movement of hanging member therein between the releasing end and the closing end, so as to prevent the hanging member from inadvertently moving out of the releasing end. When the manually actuated releasing member moves to the second position thereof, the stopper is kept away from the hanging member, allowing the hanging member to move freely.

The advantage of the present invention lies in that: the present invention has an independent support bracket arranged and constructed on the carriage assembly, which can be used to support and suspend the door leaf, and thus achieving a higher level of supporting capability. The releasing and hanging structures of the present invention do not have to bear the weight of the door leaf themselves so that they essentially sustain longer product durability, and are effortless for practical operations. Furthermore, the structures of the door leaf mounted assembly, the carriage assembly, and the manually actuated releasing member of the present invention are engineered into simplistic types and made with enhanced level of strength reliability, and thus have benefits in mass production to substantially lower down the manufacturing costs.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a perspective view illustrating the apparatus for use in mounting a movable door leaf on an overhead track in the prior art;

FIG. 2 is a perspective view illustrating the apparatus for use in mounting a movable door leaf on an overhead track in another prior art;

FIG. 3 is a schematic perspective view of the apparatus for use in mounting a movable door leaf on an overhead track applied to a shutter door according to an embodiment of the present invention;

FIG. 4 is a perspective exploded view of the apparatus for use in mounting a movable door leaf on an overhead track according to one embodiment of the present invention;

FIG. 5 is a combined view of the individual parts of the apparatus for use in mounting a movable door leaf on an overhead track in accordance with one embodiment of the present invention;

FIG. 6A is a schematic view of the apparatus for use in mounting a movable door leaf on an overhead track according to one embodiment of the present invention, in which the hanging member is in an inoperative state;

FIG. 6B is a schematic view of the apparatus for use in mounting a movable door leaf on an overhead track according to one embodiment of the present invention, in which the hanging member is in a releasing state;

FIG. 7A is a schematic view of the apparatus for use in mounting a movable door leaf on an overhead track according to one embodiment of the present invention, in which the channel is disposed with a manually actuated releasing member and the hanging member is in an inoperative state;

FIG. 7B is a schematic view of the apparatus for use in mounting a movable door leaf on an overhead track according to one embodiment of the present invention, in which the channel is disposed with a manually actuated releasing member and the hanging member is in a releasing state;

FIG. 8 is a perspective exploded view of the apparatus for use in mounting a movable door leaf on an overhead track according to another embodiment of the present invention;

FIG. 9A is a schematic view of the hanging member of the embodiment of FIG. 8 in an inoperative state;

FIG. 9B is a schematic view of the hanging member of the embodiment of FIG. 8 in a releasing state; and

FIG. 10 is a schematic perspective view of the apparatus for use in mounting a movable door leaf on an overhead track applied to a bi-fold shutter according to the present invention.

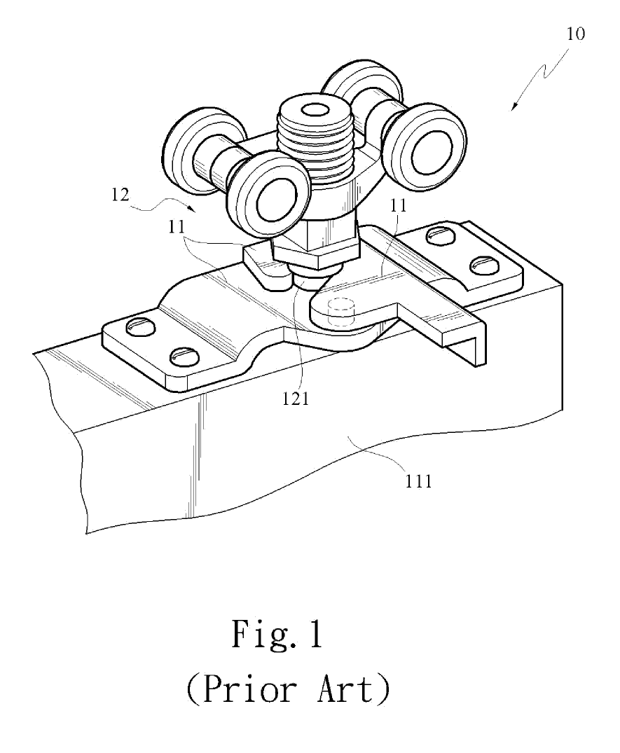

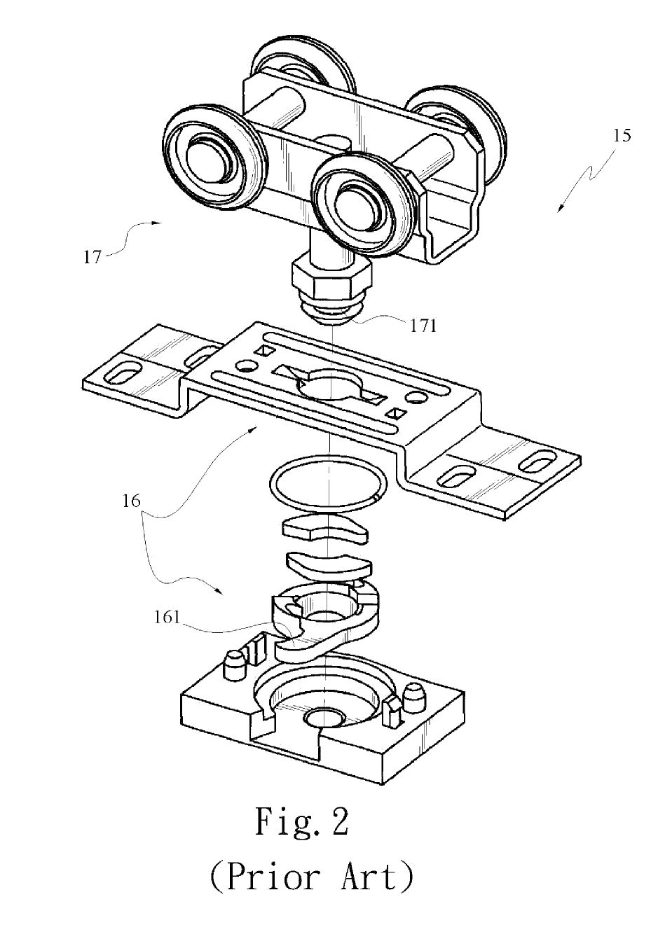

### DETAILED DESCRIPTION OF THE INVENTION

The present invention is illustrated below in great detail through embodiments with reference to the drawings.

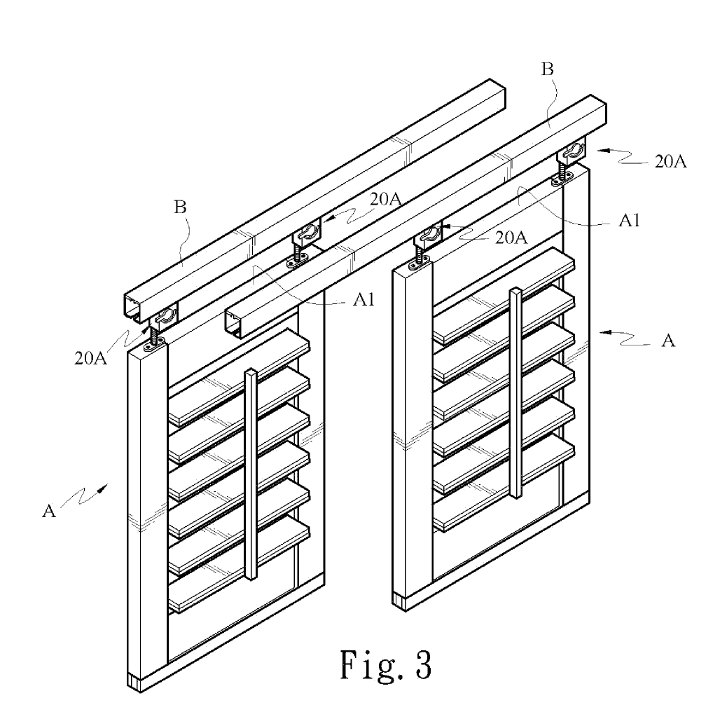

First, referring to FIG. 3, apparatus 20A for use in mounting a movable door leaf A (a shutter door in this embodiment) on an overhead track B, such that the door leaf A can traversely slide along the track B. The door leaf A is generally incorporated with two sets of the apparatus at respective upper edge portions of the door leaf A. However, the number of appropriate sets requested may be changed accordingly to the varying sizes of the door leaf A.

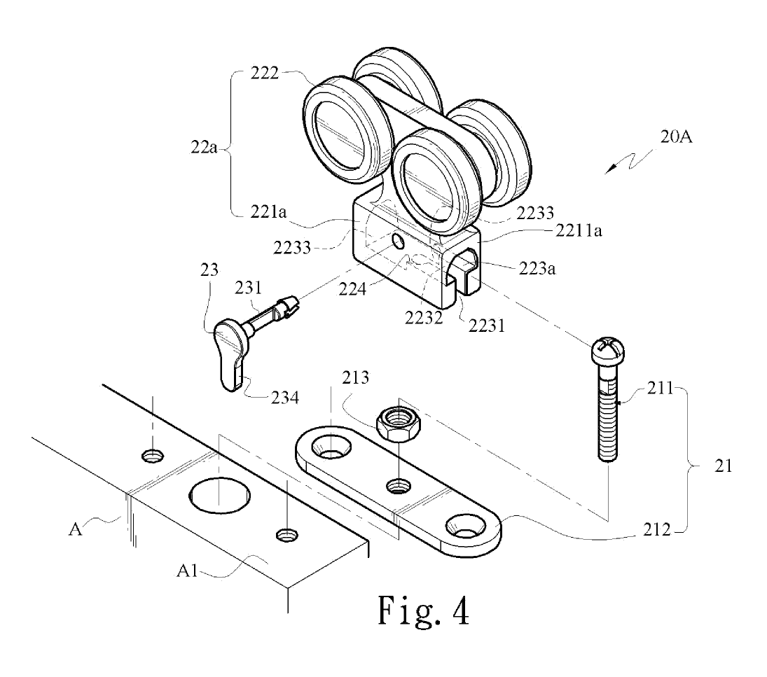

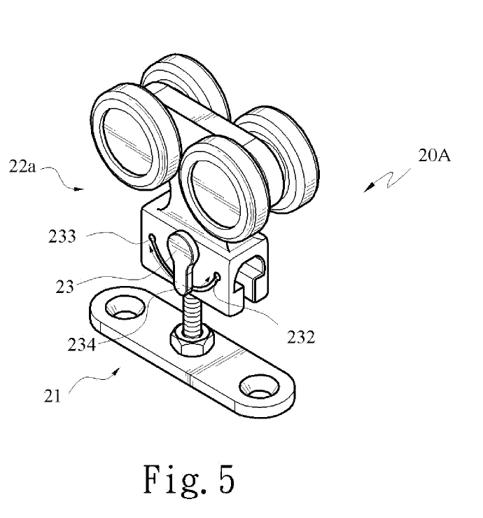

Referring to FIGS. 4 and 5, the apparatus 20A according to one embodiment of the present invention includes a door leaf mounted assembly 21 having a hanging member 211 and a mounting bracket 212 disposed on the bottom of the hanging member 211 and being capable of mounting to the upper edge portion A1 of the door leaf A; and a carriage assembly 22a having a support bracket 221a with a moving mechanism 222 assembled thereon. The support bracket 221a has a side opening 2211a forming a predetermined shaped channel 223a for the hanging member 211 to pass through and a slot 2231 extending downwardly therefrom the channel 223a with the width and the length of the slot are substantially smaller with respect to the channel 223a. The channel 223a includes a first portion 2232 completely connected to the slot 2231 having a relatively smaller depth with respect to the second portion and a second portion 2233 partially connected to the slot 2231 having a relatively larger depth with respect to the first portion. In addition, a shoulder 224 is formed therein between the first portion 2232 and the second portion 2233.

The vertically extending hanging member 211 of the door leaf mounted assembly 21 passes through both the first portion 2232 of the channel 223a and the slot 2231 to reach the second portion 2233 of the channel 223a via the shoulder 224, so as to rest against at one end of the slot 2231 which is adjacent to the second portion 2233. Moreover, the upper portion of the hanging member 211 perpendicularly hangs down to rest against the shoulder 224 and the bottom surface of the support bracket 221a, allowing the hanging member 211 to be assembled upon the support bracket 221a whereby further limited the hanging member 211 within the second portion 2233 to prevent inadvertently falling out therefrom so that the door leaf A can be fixedly mounted in place, and the carriage assembly 22a can slide traversely along the track B through utilizing the means of moving mechanism 222.

In the above embodiment of the present invention, the hanging member 211 further includes a nut 213 prescrewed thereon, and then both the hanging member and the mounting bracket 212 are securely screwed together afterwards, effecting the nut to firmly press against the mounting bracket in place. If the door leaf mounted assembly 21 is intended to be released from the carriage assembly 22a, the door leaf A can be lifted by an external force, and then the hanging member 211 of the door leaf mounted assembly 21 is subsequently moved upwardly to enter the first portion 2232 and then horizontally exit therefrom the channel 223a, and thus, the door leaf mounted assembly 21 is completely released and separated from the carriage assembly 22a.

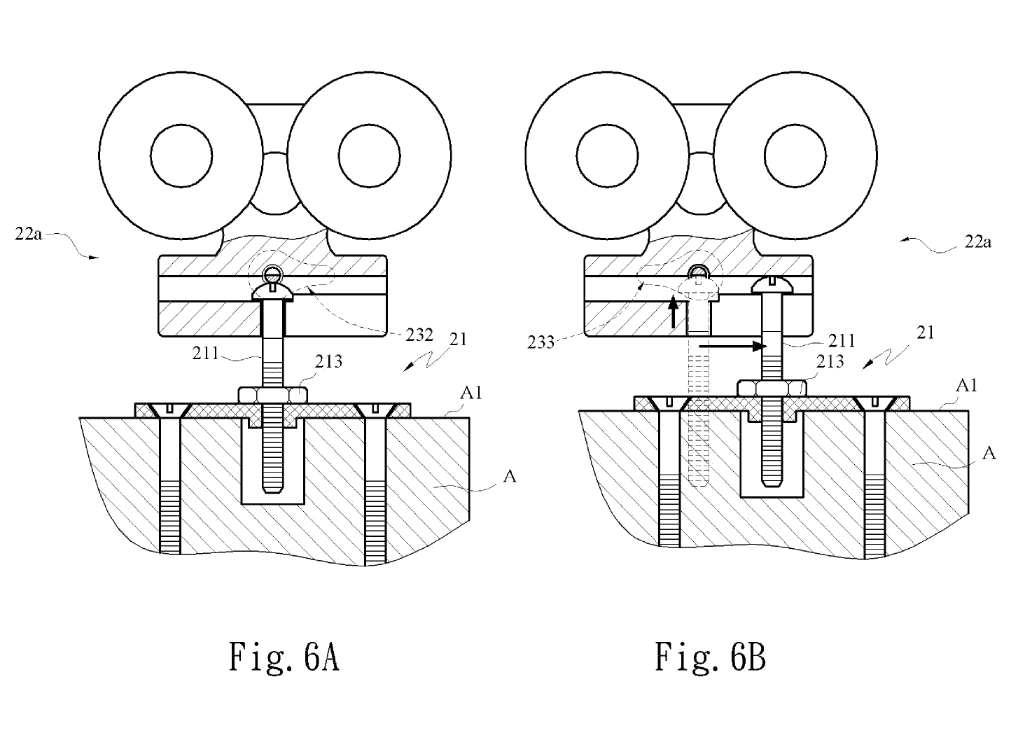

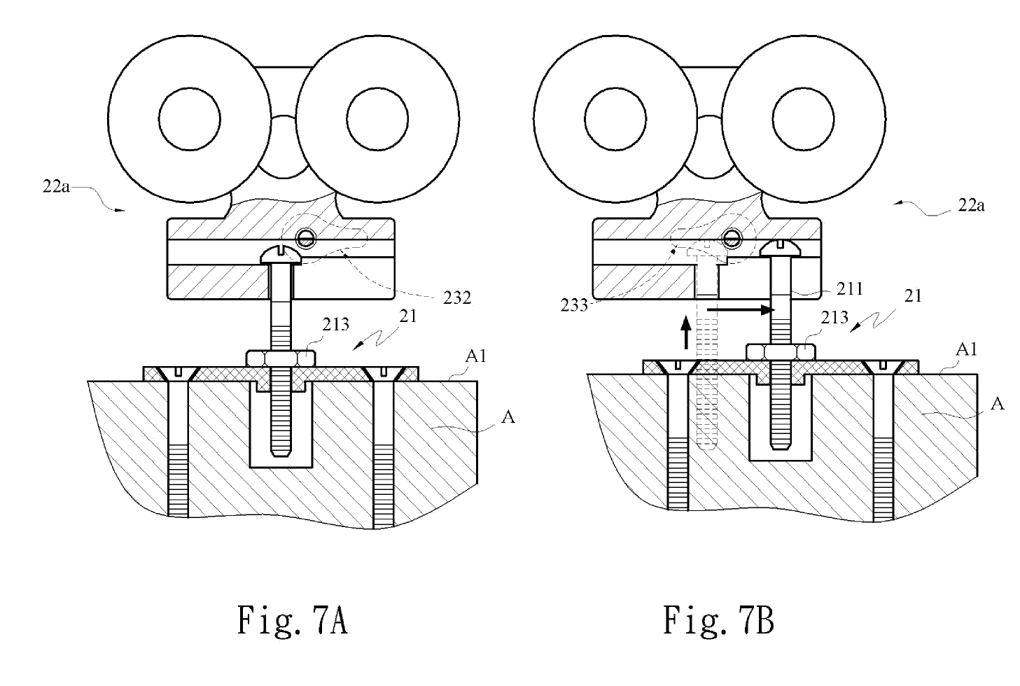

Continue referring to FIGS. 6A, 6B, 7A, and 7B, and in order to completely limit the door leaf mounted assembly 21 within the channel 223a of the carriage assembly 22a, a manually actuated releasing member 23 is mounted at the inner side surface of the upper portion of the second portion 2233 (or the first portion 2232) of the channel 223a. The manually actuated releasing member 23 has a stopper 231, which moves therein between a first position 232 and a second position 233. When moving to the first position 232, the manually actuated releasing member 23 is in an inoperative state in this embodiment, and the stopper 231 can make the hanging member 211 rest therein between the second portion 2233 and the shoulder 224 (or restrains the hanging member 211 therein between the second portion 2233 and the first portion 2232), so as to prevent the hanging member 211 from inadvertently moving out of the channel 223a of the carriage assembly 22a. When moving to the second position 233, the manually actuated releasing member 23 is in a releasing state in this embodiment, and the stopper 231 is kept away from the hanging member 211, allowing the hanging member 211 to be moved freely along the channel 223a.

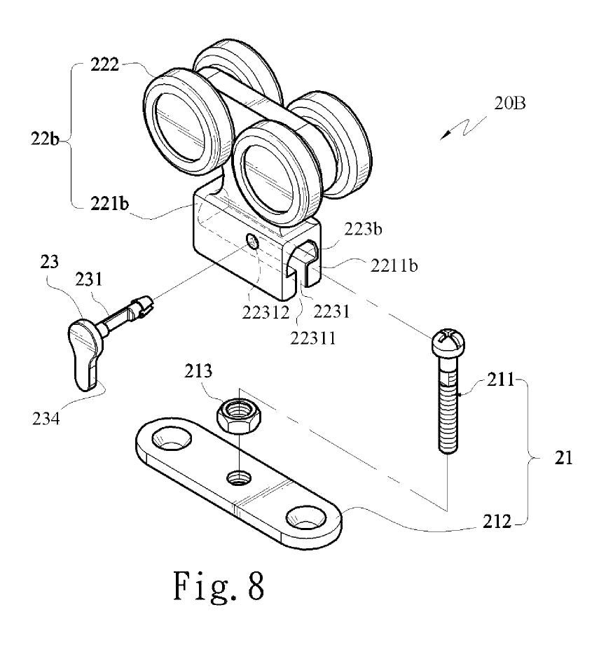

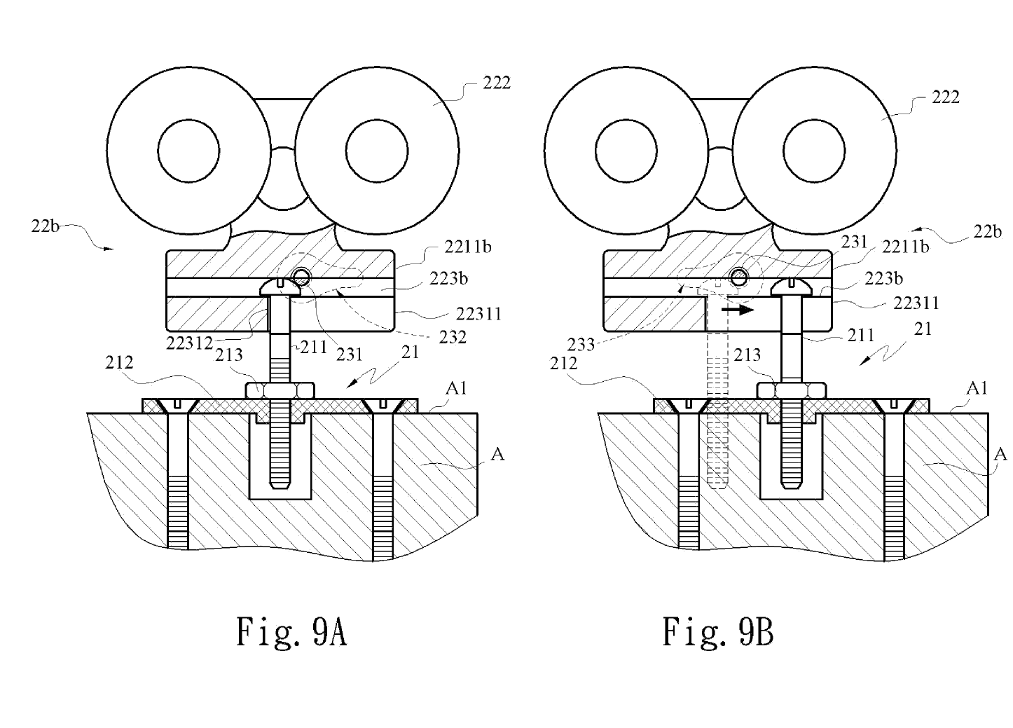

Referring to FIGS. 8, 9A, and 9B, the apparatus 20B according to another embodiment of the present invention includes: a door leaf mounted assembly 21, having a hanging member 211 and a mounting bracket 212 disposed at the lower portion of the hanging member 211 and capable of being mounted to the upper edge A1 of the door leaf A; a carriage assembly 22b, having a support bracket 221b and a moving mechanism 222 assembled on top of the support bracket 221b, in which the support bracket 221b has a side opening 211b forming a predetermined shape of channel 223b for the hanging member 211 to pass through and provided with a slot 2231 extending downwardly from the channel 223b, a width and a length of the slot 2231 are relatively smaller than those of the channel 223b, the slot 2231 has a releasing end 22311 in the vicinity to the side opening 2211b and a closing end 22312 located away from the side opening 2211b; and a manually actuated releasing member 23, mounted at inner side surface of the top wall of the support bracket 221b and being capable of moving therein between a first position 232 and a second position 233, and furthermore, the manually actuated releasing member 23 has a stopper 231.

In the above embodiment, the hanging member 211 passes through the channel 223b and the slot 2231 to rest against the closing end 22312 of the slot 2231. When the manually actuated releasing member 23 is in an inoperative state at the first position 232 thereof, the stopper 231 limits the movement of the hanging member 211 therein between the releasing end 22311 and the closing end 22312, so as to prevent the hanging member 211 from inadvertently moving out of the releasing end 22311. When the manually actuated releasing member 23 is in a releasing state at the second position 233, the stopper 231 is kept away from the hanging member 211, allowing the hanging member 211 to move freely.

In the above embodiment, the manually actuated releasing member 23 can be a moon-round shaped bar. After a hole is corresponding disposed at the assembly position of the manually actuated releasing member 23, the manually actuated releasing member 23 axially rotates between the first position 232 and the second position 233. The stopper 231 of the manually actuated releasing member 23 is the semi-circular portion located in the middle body of the manually actuated releasing member 23. At the first position 232, the solid part of the semi-circular portion is rotatably shifted to the lower half part, so as to enter the assembling path of the hanging member 211 to form a hindrance, and thus forming into a closing state; whereas at the second position 233, the hollow part of the semi-circular portion is now rotatably shifted to the lower half part, so the assembling path of the hanging member 211 is free from interference, and thus forming into a releasing state.

Of course, the manually actuated releasing member 23 can also achieve the reversible position between the first position and the second position through a latch or a ratchet, instead of being limited to the mortise lock mode with a semi-circular section provided by this embodiment.

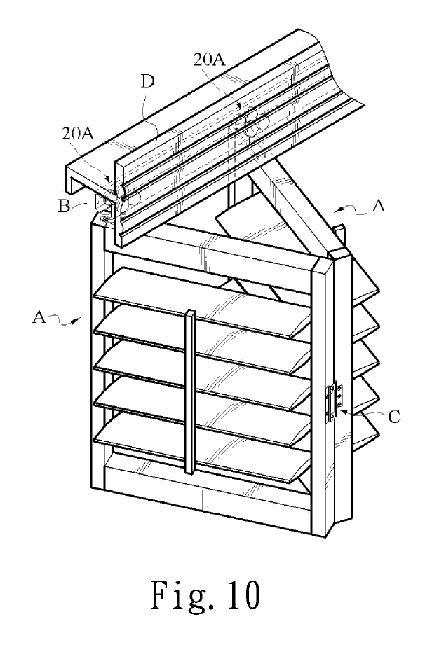

Finally, FIG. 10 is shown for two movable door leafs A (a bi-fold shutter in this embodiment) applied on a single overhead track B, the two door leafs is securely attached together by the means of two hinges C respectively disposed at a marginal edge of an adjacent portion of aforesaid door leafs, thereby such two door leafs being capable of sliding traversely beneath the overhead track B and being movable about the axis of the two hinges. To better enhance the aesthetic appeal of the apparatus 20A, a elongate facing D is preferably provided at the front wall surface of the overhead track B which has an appropriate width and the lower marginal portion of the facing B is comparatively lower to the bottommost portion of the track B as to effectively conceal most parts of the apparatus 20A.

Yet still another feature and advantage of the present invention is to provided a handle 234 formed at an end margin of the manually actuated releasing member 23 which is visibly exposed at exterior of the support bracket 221a as to manipulate and rotatably adjust the alternate movement of the manually actuated releasing member 23 therein between the first position and the second position; wherein the axis of the manually actuated releasing member 23 is essentially perpendicular to both the axis of the hanging member 211 and the longitudinal axis of the overhead track B. More specifically, the handle 234 is rotatably moved along the surface plane of the support bracket 221a, thereby obviating the horizontal movement of the handle to interfere with interior surface of the facing D when two door leafs A are traversely sliding thereon. However, this problem arose while the door leaf employed or applied with the inventions disclosed in U.S. Pat. Nos. 3,829,929 and 6,209,171, as the handle presented in both inventions is horizontally extended outwardly from the front wall surface of the door leaf, preventing an overhead track application with a facing attached thereon.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for use in mounting a movable door leaf on an overhead track comprising
a door leaf mounted assembly having a hanging member and a mounting bracket disposed on a bottom extremity of said hanging member and capable of being mounted on an upper edge of said door leaf; and
a carriage assembly having a support bracket and a moving mechanism assembled on said support bracket, wherein said support bracket is constructed and arranged with a channel forming into predetermined shape at a side opening thereof allowing said hanging member to pass through and a slot extending downwardly from said channel wherein a width and a length of said slot are substantially smaller with respect to said channel; the channel includes a first portion substantially connected to said slot having a longitudinal depth and a second portion partially connected to said slot having a relatively larger depth with respect to said first portion; and a shoulder is formed therein between said first portion and said second portion;
wherein said hanging member passes through from said first portion of said channel and said slot to reach said second portion of said channel via said shoulder thereof to rest against one end portion of said slot in the vicinity to said second portion, and an upper margin of said hanging member vertically extending downwardly to rest against said shoulder and a bottom extremity of said support bracket thereof attaching said hanging member upon said support bracket.

2. The apparatus as defined in claim 1, wherein said mounting bracket is fixedly mounted with screws upon said hanging member.

3. The apparatus as defined in claim 2, wherein said hanging member further comprises a prescrewed nut, and both said hanging member and said mounting bracket are fixedly screwed together, effecting said nut to firmly press against said mounting bracket in place.

4. The apparatus as defined in claim 1, further comprising a manually actuated releasing member having a stopper partially passes through said channel and being capable of moving therein between a first position and a second position; when said manually actuated releasing member moves to the first position, said stopper limits the movement of said hanging member therein between said second portion and said shoulder thereof preventing said hanging member from inadvertently moving out of said side opening; when said manually actuated releasing member moves to said second position, said stopper is located away from said hanging member, allowing said hanging member to move freely.

5. The apparatus as defined in claim 1, further comprising a manually actuated releasing member having a stopper partially passes through said channel and being capable of moving therein between a first position and a second position, when said manually actuated releasing member moves to said first position, said stopper limits the movement of said hanging member therein between said first portion and said second portion thereof preventing said hanging member from inadvertently moving out of said side opening; when said manually actuated releasing member moves to said second position, said stopper is located away from said hanging member, allowing said hanging member to move freely.

6. The apparatus as defined in claim 5, wherein the manually actuated releasing member is a moon-round shaped bar, movably rotating between said first position and said second position therein, and said stopper of said manually actuated releasing member is a body in the form of half of a circle of said manually actuated releasing member.

7. The apparatus as defined in claim 1, wherein said first position is an inoperative position.

8. The apparatus as defined in claim 1, wherein said second position is a releasing position.

9. An apparatus for use in mounting a movable door leaf on an overhead track comprising:
a door leaf mounted assembly having a hanging member and a mounting bracket disposed on a bottom extremity of said hanging member and capable of being mounted on an upper edge of said door leaf;
a carriage assembly having a support bracket and a moving mechanism assembled on said support bracket, wherein said support bracket is constructed and arranged with a channel forming into predetermined shape at a side opening thereof allowing said hanging member to pass through and a slot extending downwardly from said channel wherein a width and a length of said slot are substantially smaller with respect to said channel; and said slot has a releasing end adjacent to said side opening and a closing end away from said side opening; and
a manually actuated releasing member having a stopper partially passes through said channel and being capable of moving therein between a first position and a second position;
wherein said hanging member passes through both said channel and said slot to rest against said closing end of said slot; when said manually actuated releasing member moves to said first position, said stopper limits the movement of said hanging member therein between said releasing end and said closing end as to prevent said hanging member from moving out of said releasing end; and when said manually actuated releasing member moves to said second position, said stopper is kept away from said hanging member, allowing said hanging member to move freely.

10. The apparatus as defined in claim 9, wherein said mounting bracket is fixedly mounted with screws upon said hanging member.

11. The apparatus as defined in claim 9, wherein the hanging member further comprises a prescrewed nut, and both said hanging member and said mounting bracket are fixedly screwed together, effecting said nut to firmly press against said mounting bracket in place.

12. The apparatus as defined in claim 9, wherein the manually actuated releasing member is a moon-round shaped bar, movably rotating therein between said first position and said second position, and said stopper of said manually actuated releasing member is a body in the form of half of a circle of said manually actuated releasing member.

13. The apparatus as defined in claim 9, wherein said first position is an inoperative position.

14. The apparatus as defined in claim 9, wherein said second position is a releasing position.

15. An apparatus for use in mounting a movable door leaf on an overhead track comprising
an overhead track, having a predetermined length;
a carriage assembly comprising a moving mechanism assembled upon a longitudinal axis of said overhead track wherein a support bracket having a slot opened downwardly is constructed and arranged beneath said moving mechanism, and said slot is connected to a first portion and a second portion;
a door leaf mounted assembly comprising a hanging member wherein the upper marginal edge of said hanging member being capable of moving traversely within said slot and being rotated about its own longitudinal axis, and said axis is perpendicular to the orientation of the longitudinal axis of said overhead track, when said hanging member moves to the second portion allowing the vertically upward and downward motion about its own axis;
a mounting bracket disposed on a lower margin of said hanging member and mounted on a predetermined edge of said door leaf; and
a manually actuated releasing member is constructed and arranged upon said support bracket passing through a stopper of said slot and being rotatable about its own axis between a first position and a second position, said pivotally rotating axis is perpendicular with respect to both the longitudinal axis of said overhead track and the axis of said hanging member;
wherein when said manually actuated releasing member moves to said first position thereof, said stopper limits the movement of the upper marginal edge of said hanging member inadvertently moving away from said second position towards said first position thereof within said slot, when said manually actuated releasing member moves to said second position, allowing said hanging member to freely move therein.

16. The apparatus as defined in claim 15 wherein said manually actuated releasing member is provided with a handle having a predetermined length and is exposed at exterior of said support bracket as to adjust the alternate position of said manually actuated releasing member, and the orientation of the longitudinal axis of said handle is perpendicular with respect to the pivotally rotating axis of said manually actuated releasing member.

17. The apparatus as defined in claim 15 wherein a facing is provided at the front wall surface of said overhead track forming into a predetermined width so that bottom margin of said facing is substantially lower than the bottommost edge of said track.

18. The apparatus as defined in claim 15 comprising two panels of door leafs having an apparatus respectively mounted upon each of said two door leafs, and at least a hinge is pivotally mounted thereon to the edge margin of the adjacent portion of said two door leafs.

19. The apparatus as defined in claim 15, wherein said first position is an inoperative position.
